(19) United States
(12) Patent Application Publication
(10) Pub. No.: US 2024/0002736 A1
(43) Pub. Date: Jan. 4, 2024

(54) RANDOM ACRYLIC TERPOLYMERS OF CONTROLLED MOLECULAR MASS USEFUL AS WATER IN CRUDE OIL EMULSIONS DESTABILIZERS

(71) Applicant: Instituto Mexicano del Petróleo, Mexico City (MX)

(72) Inventors: César Andrés Flores Sandoval, Mexico City (MX); Flavio Salvador Vázquez Moreno, Mexico City (MX); Gerardo Zavala Olivares, Mexico City (MX); Fernando Álvarez Ramírez, Mexico City (MX); Edgar Benedicto Zamora Guerrero, Mexico City (MX); Jessica Valeria Fuentes Santiago, Mexico City (MX); Citlally Janinne Vargas Martínez, Mexico City (MX); Gerardo Nicolas Rodríguez Araujo, Mexico City (MX); Enrique Cevada Maya, Mexico City (MX)

(21) Appl. No.: 18/082,306

(22) Filed: Dec. 15, 2022

(30) Foreign Application Priority Data
Jun. 30, 2022 (MX) MX/A/2022/008218

(51) Int. Cl. C10G 33/04; C08F 220/14; B01D 17/04

(52) U.S. Cl. CPC C10G 33/04; C08F 220/14; B01D 17/047; C10G 2300/308; C10G 2300/302; C10G 2300/206

(57) ABSTRACT

The present disclosure is related to novel random terpolymers of alkyl-acrylate, carboxyalkyl-acrylate, and alkoxyalkyl-acrylate, and to processes for their preparation, and processes for their use as dehydrating-desalting agents of crude oil, particularly, their use as destabilizers of water-in-crude oil (W/O) emulsions, including their use to remove water and salts dissolved in crude oils with gravities between around 10 and around 40° API.

### RELATED APPLICATIONS

This patent application claims priority under 35 U.S.C. § 119 of Mexican Patent Application MX/a/2022/008218, filed on Jun. 30, 2022, the disclosure of which is incorporated herein by reference.

### TECHNICAL FIELD OF THE DISCLOSURE

The present disclosure is related to novel random terpolymers of alkyl-acrylate, carboxyalkyl-acrylate, and alkoxyalkyl-acrylate, and to processes for their preparation, and processes for their use as dehydrating-desalting agents of crude oil, particularly, their use as destabilizers of water-in-crude oil (W/O) emulsions, including their use for removal the water present in crude oil and salts dissolved therein, particularly, their use for crude oils with gravities between around 10 and around 40° API.

### BACKGROUND OF THE DISCLOSURE

One of the main problems in the petroleum industry is the mutual extraction of crude oil and water. The stirring of both phases because of the turbulent flow through equipment and pipelines leads to the formation of water-in-crude oil (W/O) emulsions, because of the dispersion of water as droplets in the organic phase. It is worth mentioning that this type of mixtures present high stability because the compounds present in crude oil with surfactant activity (mainly asphaltenes) are adsorbed at the water/crude oil interface, forming an interfacial film that surrounds the dispersed droplets. This interfacial film confers high stability on the emulsified water droplet, preventing the coalescence among them. For this reason, the presence of an emulsion represents a serious problem at industrial level, because, in the transport and refining stages, it induces corrosion and scaling in equipment [6], catalyst poisoning [6], increased cost of transport, among others [8]. In addition to these drawbacks, the exportation of crude oil with a water content higher than 1 vol %, as stipulated in international statutes, leads to an economic penalty.

To avoid the complications described above, it is necessary to remove or reduce the water present in crude oils to a volume lower than 1 vol %, for which, different conditioning methods have been used. One of the most widely employed is the chemical treatment, which consists of the addition of compounds capable of destabilizing the water/crude oil interface and, therefore, inducing the coalescence of the emulsified water droplets. Countless compounds have been evaluated as demulsifying agents of crude oil; however, the triblock polymers of polyethylene oxide-polypropylene oxide-polyethylene oxide (PEO-PPO-PEO) are the most used industrially. Although several works report that these compounds exhibit significant performance in water removal, it is necessary to apply these products as a formulation of at least three PEO-PPO-PEO basics of different molecular mass, since a single triblock polymer does not possess the three necessary properties to dehydrate a crude oil: breaker, coalescer and clarifier. Moreover, their performance under acidic conditions significantly decreases because of the chemical degradation of the terminal hydroxyl groups. Another drawback to use these products is their production process, since it involves two synthesis stages, both at high pressure and temperature. This obviously has a meaningful impact over the commercial value of formulations based on triblock polymers, because it is necessary to carry out this synthesis for each basic, which evidently leads to a minimum of six reactions to obtain only one commercial formulation.

In order to find alternatives to the use of demulsifying formulations based on polyethers, the ionic liquids have been evaluated as dehydrating agents at laboratory level. Several reports have expressed their high efficiency in the removal of emulsified water; however, their highly expensive synthesis process limits their use at industrial level and, therefore, makes them an unviable alternative to replace demulsifier agents based on polyethers.

On the other hand, polymers based on vinylic have shown high performance as demulsifying agents. U.S. Pat. No. 4,968,449 describes the use of alkoxylated vinyl polymers for the removal of emulsified water from crude oils, however, it describes only one crude oil from a Wyoming oil field was employed, and the efficiency of vinyl polymers is described only qualitatively, using an arbitrary scale. Recently, the application of random copolymers based on acrylic has received great attention due to the good performance shown in the removal of emulsified water, which is noticeably superior to that of commercial formulations based on polyethers. It is important to point out that this type of random copolymers do not present hydrophilic and lipophilic block sequences; but rather, a distribution of structural units in the chains that is completely random. Mexican Patent No. 386485 and U.S. Pat. No. 10,975,185 report the use of random bipolymers based on alkyl-acrylate and aminoalkyl-acrylate of controlled molecular mass as dehydrating agents in heavy and light crude oils. These acrylic random bipolymers displayed superior performances to remove the emulsified water in heavy (12.31 and 18.77° API) and light (38.71° API) crude oils compared with the FDH-1 commercial formulation, which is made of four triblock polymers PEO-PPO-PEO of different molecular mass. For example, alkylacrylic-aminoalkylacrylic bipolymers with monomeric ratios of 60/40, 70/30 and 80/20 w/w %, at a dosage of 1000 ppm, removed the entire volume of emulsified water in the crude oil of 12.31° API at 60 min, whereas the FDH-1 commercial formulation was only capable of withdrawing 83 vol %. In relation to the assessments in the light crude oil of 38.71° API, all random bipolymers with monomeric ratio of 70/30 w/w % and average molecular masses between 9800 and 24000 g mol⁻¹ significantly exceeded the maximum dehydrating efficiency exhibited by the FDH-1 commercial formulation (51 vol %). Particularly, the three bipolymers with monomeric ratio of 70/30 w/w % and molecular masses greater than 10000 g mol⁻¹ exhibited dehydrating efficiencies higher to 80 vol %.

Likewise, U.S. Pat. No. 10,793,783 and Canadian Patent No. 3,013,494 describe an evaluation of random bipolymers based on alkyl-acrylate and carboxyalkyl-acrylate of different monomeric compositions and controlled molecular mass as demulsifying agents for extra-heavy crude oils (6.11 and 7.55° API), in which, the AF-182 bipolymer (with 80/20 monomer weight ratio), dosed at different concentrations, displayed high water removal efficiencies, >60% at 500 ppm and 100% at 1500 ppm. For example, in the extra-heavy crude oil of 7.55° API, it achieved a removal of 100%, at a low dosage of 250 ppm; on the other hand, in the heavy crude oil of 16.81° API, it showed the highest water removal efficiency, 100%, at a dosage of 1500 ppm and, besides, with an excellent clarification of the removed water. Finally, in the light crude oil of 38.71° API, the bipolymer BF-273, with a monomeric ratio of 70/30 w/w %, removed the 100% of the emulsified water at a dosage of 1500 ppm during the first hours of the assessment. In general, high water removal efficiencies were observed with these bipolymers, which were higher than that shown by the commercial formulation based on polyethers, known as FDH-1.

On the other hand, Mexican patent application no. Mx/a/2020/011505 and the US patent application publication no. 20220135886 describe the application of ethylene alkanoate-alkyl acrylate bipolymers that comprise chains with random monomeric sequences, as dehydrating agents for heavy crude oils. These random acrylic bipolymers display good performance in the removal of emulsified water in crude oils with gravities from 4 to 35° API, outperforming the FC-01 commercial formulation based on polyethers in capacities as emulsion breaking, water droplet coalescence rate, and clarification of the removed aqueous phase. In fact, random acrylic bipolymers of molecular masses between 3000 and 4200 g mol⁻¹ were evaluated in a heavy crude oil of 20.17° API, and all random bipolymers exceeded 80% of maximum water removal efficiency. The best bipolymer (BV-642, M̅ₙ=3668 g mol⁻¹) was evaluated in the extra heavy crude oil of 4.64° API, being capable of removing all the emulsified water, whereas the FC-01 formulation withdrew 83 vol %, reaching its maximum efficiency at 180 min, and showing a total activity suppression from that time until the end of the assessment.

Regarding its evaluation in the light crude oil of 33.1° API, the BV-642 bipolymer also exhibited a notably higher dehydrating efficiency compared with that shown by the FC-01 commercial formulation (25 vol %), removing all the emulsified water at the end of the evaluation. Likewise, its coalescence rate was outstandingly higher than that of the dehydrating commercial formulation.

The aforementioned reports are clear examples of the superior performance of acrylic random bipolymers as dehydrating agents for crude oils of different characteristics. Additionally, other documents also report the use of acrylic terpolymers for the destabilization of crude oil/water emulsions, as well as other uses for the treatment of crude oil and its derivatives. For example, Ma et al. [27] reported the synthesis of a terpolymer constituted by the combination of aminocarboxylate-allylpolyacrylate, hydroxyethyl acrylate, and maleic anhydride, as well as its subsequent use as a decalcifying agent for a heavy crude oil with a density of 0.8658 g cm⁻¹. Additionally, Feng et al. [28] synthesized terpolymers of different chain lengths, with sequences of vinyl acetate, maleic anhydride, and alkyl acrylates, in order to assess their performance as cold flow improvers for diesel.

Regarding crude oil dehydrating, the Mexican patent application no. Mx/a/2020/002212 describes the use of terpolymers formed by random sequences of alkyl acrylate, aminoalkyl acrylate, and carboxyalkyl acrylate, as dehydrating agents for crude oils with gravities between 3 and 40° API. These terpolymers were synthesized by emulsion polymerization in a semi-continuous process and evaluated as dehydrating agents in three extra-heavy crude oils (7.55, 6.11 and 4.55° API). The AAmC-9552, AAmC-8111, and AAmC-6131 terpolymers, with monomeric ratios of 90/5/5, 80/10/10, and 60/10/30 w/w/w % and molecular masses from 11839 to 16418 g mol⁻¹, showed the highest water removal efficiencies and furthermore, an excellent water clarification capacities, reaching dehydrating efficiencies superior to those of a commercial formulation based on polyethers, which was also employed in U.S. Pat. No. 10,793,783 and Canadian Patent No. 3,013,494, as well as, with respect to a high-performance ionic liquid.

Similarly, the Mexican patent application no. Mx/a/2020/010501 describes the use of terpolymers, where the polymeric chains are formed by random distributions of alkyl acrylate, aminoalkyl acrylate, and alkoxyalkyl acrylate, as dehydrating agents for crude oils, whose gravities are within the range from 8 to 40° API. The emulsion-removing capabilities of these terpolymers were remarkably superior to those exhibited by the FD-01 commercial formulation, as well as to the performance of the F-46 formulation, which is a widely used dehydrating agent in the petroleum industry (commonly known as “the universal demulsifier”), being the terpolymers with monomeric ratios of 60/30/10 and 70/20/10 w/w/w % and molecular masses of 17,445 and 15,273 g mol⁻¹, respectively, those that achieved the highest water removal efficiency, as well as a better clarification than both commercial formulations used in the assessments.

As can be seen, acrylic random bipolymers and terpolymers are a viable industrial alternative as dehydrating agents for a wide variety of crude oils. However, relatively little research work has been developed related to their use in the crude oil treatment and the mechanisms that lead them to greater and faster destabilization of the water/crude oil interface compared with commercial polyethers. Similarly, the use of polymers base on alkoxyalkyl acrylate has been reported in other works; nevertheless, most have focused their application in areas outside the oil industry. For example, U.S. Pat. No. 8,318,832 describes the use of polymers based on alkoxyalkyl acrylate and hydroxyalkyl acrylate in the construction of optical parts of intraocular lenses. Similarly, U.S. Pat. No. 3,780,003 reports the synthesis of polymers based on alkoxyalkyl acrylate and hydroxyalkyl acrylate as films or coatings for various applications: either in adhesive bandages for medical or surgical applications, as decorative nail coatings, as cosmetics, among others. Obviously, the synthesis of the alkoxyalkyl polyacrylates of these examples is not carried out by emulsion polymerization techniques, as the reported in the technical description of the present disclosure.

Therefore, in the framework of developing novel random polymers with crude oil-dehydrating functionality, as summarized in the previously described documents, the present disclosure provides novel random terpolymers based on alkyl acrylate, carboxyalkyl acrylate, and alkoxyalkyl acrylate, synthesized by an original semi-continuous emulsion polymerization process and their application as destabilizing agents of complex W/O emulsions, present in a wide variety of crude oils. The random terpolymers of the present disclosure outperform all of the random polymers of the previously described references because one of the objectives derives from the need to provide novel random terpolymers based on alkyl acrylate, carboxyalkyl acrylate, and alkoxyalkyl acrylate as agents to remove emulsified water in crude oil. Another objective of the present disclosure is to provide a novel emulsion polymerization process for the synthesis of the foregoing random terpolymers ensuring that these present randomness in their arrangement along the chain, as well as a low polydispersity system. An additional objective of the present disclosure is to apply random terpolymers capable of breaking the asphaltene layer surrounding the dispersed water droplets, inducing their coalescence, and clarifying the separated aqueous phase.

### SUMMARY

This summary is intended to introduce the subject matter of the present disclosure, but does not cover each and every embodiment, combination, or variation that is contemplated and described within the present disclosure. Further embodiments are contemplated and described by the disclosure of the detailed description, drawings, and claims.

The present disclosure relates to novel terpolymers (based on alkyl-acrylate, carboxylalkyl-acrylate, and alkoxylalkyl-acrylate monomers) of high randomness and controlled molecular mass. The random terpolymers have advantageous properties as demulsifying agents for water-in crude oil (W/O) emulsions, such as W/O emulsions in crude oils with gravities between 10 and 40° API.

In at least one embodiment, the terpolymers useful as demulsifying and dehydrating agents are based on random terpolymers having structural formula (1) below:

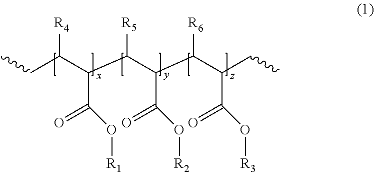

wherein:
each R₁ is independently chosen from substituted or unsubstituted CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethylene glycol)ethylether), C₈H₁₇ (2-ethylhexyl), C₆H₁₉ (3,5,5-trimethylhexyl), C₈H₁₇ (n-octyl), C₈H₁₇ (iso-octyl), C₃H₉ (ethylene glycol phenylether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₃H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (n-tridecyl) or C₂₂H₄₅ (behenyl) wherein the substitution can be one or more chain inserted heteroatoms, aryl or heteroaryl groups;
each R₂ is independently chosen from C₃H₅O₂ (2-carboxyethyl), C₄H₇O₂ (3-carboxypropyl), C₅H₉O₂ (4-carboxybutyl), C₆H₁₁O₂ (5-carboxypentyl), C₅H₉O₂ (3-methyl-3-carboxypropyl), C₅H₉O₂ (2,2-dimethyl-2-carboxyethyl), C₆H₁₁O₂ (3,3-dimethyl-3-carboxypropyl), C₆H₁₁O₂ (4-methyl-4-carboxybutyl);
each R₃ is independently chosen from C₂H₅O (methoxymethyl), C₃H₇O (2-methoxyethyl), C₄H₉O (2-ethoxyethyl), C₄H₉O (3-methoxypropyl), C₅H₁₁O (3-methoxybutyl), C₅H₁₁O (4-methoxybutyl), C₆H₁₃O (5-methoxypentyl), C₆H₁₃O (4-methoxypentyl), C₆H₁₃O (3-methoxypentyl), C₆H₁₃O (4-ethoxybutyl);
each of R₄, R₅, and Rₑ are independently selected from H (hydrogen) and CH₃ (methyl);
x is an integer from about 1 to about 1220;
y is an integer from about 1 to about 500; and
z is an integer from about 1 to about 500;
and the polymeric subunits of x alkyl-acrylate monomers, y carboxyalkyl-acrylate monomers, and z alkoxyalkyl-acrylate monomers can be present in any order.

The random terpolymers are based on alkyl acrylate, carboxyalkyl acrylate, and alkoxyalkyl acrylate and have an average molecular weight of from about 1000 g/mol to about 720,000 g/mol.

The present disclosure also provides production processes and uses of the random terpolymers as demulsifying agents. Generally, the random terpolymers are synthesized by combining three different monomers (alkyl-acrylate, carboxylalkyl-acrylate, and alkoxylalkyl-acrylate monomers) in a polymerization reaction. The resulting terpolymer includes a statistical distribution of polymeric subunits of the three different monomers along the polymer chain as illustrated by structural formula (1).

### BRIEF DESCRIPTION OF THE DRAWINGS

The figures accompanying the present disclosure are described below in order to have a better understanding of the objectives, without that, thereby, limiting its scope.

FIG. 1 reports the water removal efficiencies of the random terpolymers based on alkyl acrylate, carboxyalkyl acrylate, and alkoxyalkyl acrylate of the BuCE-2 series, the FD-01 commercial formulation, and the F-46 universal demulsifier, which were evaluated in the AC1 crude oil (21° API) at 80° C. and a dosage of 1000 ppm.

FIG. 2 shows the clarifying performance of the BuCE-9552 random terpolymer, the FD-01 commercial formulation, and the F-46 universal demulsifier. Besides, it contains the respective micrographs of the organic phase after the assessment of the dehydrating efficiency of the above products, which was reported in FIG. 1.

FIG. 3 displays the dehydrating efficiencies of the novel random terpolymers based on alkyl acrylate, carboxyalkyl acrylate, and alkoxyalkyl acrylate corresponding to the terpolymers of the BuCE-1 series, as well as those of the FD-01 commercial formulation and the F-46 universal demulsifier. All of them were evaluated in the AC1 heavy crude oil (21° API) at a temperature of 80° C. and a dosage of 500 ppm.

FIG. 4 and FIG. 5 show the clarifying capacities of the random terpolymers based on alkyl acrylate, carboxyalkyl acrylate, and alkoxyalkyl acrylate for the BuCE-6131, BuCE-7211, BuCE-7121, BuCE-8111, and BuCE-9551 terpolymers, as well as the FD-01 commercial formulation and the F-46 universal demulsifier, after the assessment reported in FIG. 3. Likewise, the micrographs of the organic phase treated with each of the products mentioned above are displayed.

FIG. 6 reports the dehydrating efficiencies of the random terpolymers based on alkyl acrylate, carboxyalkyl acrylate, and alkoxyalkyl acrylate of the BuCE-2 series, the FD-01 commercial formulation and the F-46 universal demulsifier, which were evaluated in the AC2 heavy crude oil (15.6° API) at 80° C. and a dosage of 1500 ppm.

FIG. 7 displays the aqueous phase clarification capabilities of the BuCE-7212 and BuCE-7122 random terpolymers, as well as the FD-01 commercial formulation and the F-46 universal demulsifier after the evaluation corresponding to FIG. 6. The respective micrographs of the crude oil after treatment with each product are also shown.

FIG. 8 reports the demulsifying performances of the random terpolymers based on alkyl acrylate, carboxyalkyl acrylate, and alkoxyalkyl acrylate of the BuCE-1 series, the FD-01 commercial formulation and the F-46 universal demulsifier, which were evaluated in the AC2 heavy crude oil (15.6° API) at 80° C. and a dosage of 1000 ppm.

FIG. 9 exhibits the clarifying capacities of the BuCE-7211 random terpolymer based on alkyl acrylate, carboxyalkyl acrylate, and alkoxyalkyl acrylate, the FD-01 formulation and the F-46 universal demulsifier obtained from the evaluation reported in FIG. 8. In addition, the respective micrographs of the organic phase after the treatment with each of the aforesaid products are shown.

FIG. 10 displays the performance of the random terpolymers based on alkyl acrylate, carboxyalkyl acrylate, and alkoxyalkyl acrylate corresponding to the BuCE-2 series and the FD-01 commercial formulation and the F-46 universal demulsifier in the AC3 light crude oil (36.3° API) at 80° C. and a dosage of 500 ppm.

FIG. 11 and FIG. 12 show the clarifying capacities of the random terpolymers BuCE-6132, BuCE-7212, BuCE-7122, BuCE-8112, and BuCE-9552; as well as the FD-01 commercial formulation and the F-46 universal demulsifier, and their respective micrographs upon completion of the evaluation whose results are reported in FIG. 10.

### DETAILED DESCRIPTION

Disclosed herein are randomly formed terpolymers having structural formula (1) below:

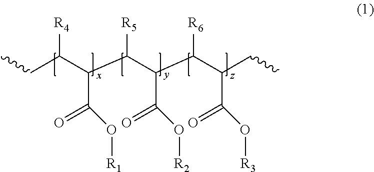

wherein:
each R₁ is independently chosen from substituted or unsubstituted CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethylene glycol)ethylether), C₈H₁₇ (2-ethylhexyl), C₆H₁₉ (3,5,5-trimethylhexyl), C₈H₁₇ (n-octyl), C₈H₁₇ (iso-octyl), C₃H₉ (ethylene glycol phenylether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₃H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (n-tridecyl) or C₂₂H₄₅ (behenyl) wherein the substitution can be one or more chain inserted heteroatoms, aryl or heteroaryl groups;
each R₂ is independently chosen from C₃H₅O₂ (2-carboxyethyl), C₄H₇O₂ (3-carboxypropyl), C₅H₉O₂ (4-carboxybutyl), C₆H₁₁O₂ (5-carboxypentyl), C₅H₉O₂ (3-methyl-3-carboxypropyl), C₅H₉O₂ (2,2-dimethyl-2-carboxyethyl), C₆H₁₁O₂ (3,3-dimethyl-3-carboxypropyl), C₆H₁₁O₂ (4-methyl-4-carboxybutyl);
each R₃ is independently chosen from C₂H₅O (methoxymethyl), C₃H₇O (2-methoxyethyl), C₄H₉O (2-ethoxyethyl), C₄H₉O (3-methoxypropyl), C₅H₁₁O (3-methoxybutyl), C₅H₁₁O (4-methoxybutyl), C₆H₁₃O (5-methoxypentyl), C₆H₁₃O (4-methoxypentyl), C₆H₁₃O (3-methoxypentyl), C₆H₁₃O (4-ethoxybutyl);
each of R₄, R₅, and R₆ are independently selected from H (hydrogen) and CH₃ (methyl);
x is an integer from about 1 to about 1220;
y is an integer from about 1 to about 500; and
z is an integer from about 1 to about 500;
and the polymeric subunits of x alkyl-acrylate monomers, y carboxyalkyl-acrylate monomers, and z alkoxyalkyl-acrylate monomers can be present in any order.

The randomly formed terpolymers are based on alkyl acrylate, carboxyalkyl acrylate, and alkoxyalkyl acrylate and have an average molecular weight of from about 1000 g/mol to about 720,000 g/mol.

Further disclosed herein are processes for preparing the disclose terpolymers. Selected amounts of alkyl acrylate, carboxyalkyl acrylate and alkoxyalkyl acrylate monomers are reacted together via emulsion polymerization via a semi-continuous process thereby forming the destabilizing agents. The disclosed agents are capable of destabilizing water in oil (W/O) emulsions in crude oils having specific gravities from about 10 to about 40° API, as well as the salts dissolved in the aqueous phase. The process is conducted under strict starve-fee conditions that are described in U.S. Pat. Nos. 9,120,885, 9,932,430, and 10,213,708, each of which is hereby incorporated by reference herein.

The process requires that the monomeric ratio in the addition tank or pre-emulsion is maintained as follows: the alkyl acrylate monomer is set up on an interval from about 55.0 to about 99.4 wt %, the carboxyalkyl acrylate monomer is set up on an interval from about 0.3 to about 44.7 wt %, and the alkoxyalkyl acrylate monomer is set up on an interval from about 0.3 to about 44.7 wt %. The feeding rate of the content of the addition tank is adjusted in such way that addition to the reaction vessel is complete after 180 to 220 min. Once the reaction is completed, a latex is obtained and is submitted to a distillation process at a temperature between about 85 and about 120° C. In this way, a dry polymer is obtained, which is then dissolved in an organic solvent, for example, dichloromethane, methanol, ethanol, isopropanol, chloroform, benzene and their derivatives, such as toluene, xylene, jet fuel and naphtha. The solvents can be utilized alone or in combination. The obtained dissolution of each acrylic random terpolymer is applied as demulsifying agent in crude oils with gravities ranging from about 10 to about 40° API. Typically, the concentration of the acrylic random terpolymer in the organic solvent or solvents is set up on an interval from about 3 to about 50 wt %; and its dosage in the crude oil can be set up on an interval of concentrations from about 5 to about 3000 ppm.

To perform the crude oil dehydration, an adequate amount of the alkyl acrylate, carboxyalkyl acrylate, and alkoxyalkyl acrylate random terpolymer is added to the crude oil to be treated, with gravities ranging from about 10 to about 40° API, inducing the destabilization of the asphaltenic barrier that surrounds the emulsion water droplets, and the subsequent separation of the aqueous and organic phases.

The following are non-limiting examples of alkyl acrylate monomers suitable for use in forming the disclosed terpolymers: methyl acrylate, methyl methacrylate, ethyl acrylate, ethyl methacrylate, n-butyl acrylate, n-butyl methacrylate, iso-butyl acrylate, iso-butyl methacrylate, tert-butyl acrylate, tert-butyl methacrylate, pentyl acrylate, pentyl methacrylate, hexyl acrylate, hexyl methacrylate, (di(ethylene glycol)ethyl ether acrylate), (di(ethylene glycol)ethylether) methacrylate, 2-ethylhexyl acrylate, 2-ethylhexyl methacrylate, (3,5,5-trimethylhexyl) acrylate, (3,5,5-trimethylhexyl) methacrylate, n-octyl acrylate, n-octyl methacrylate, iso-octyl acrylate, iso-octyl methacrylate, (ethylene glycol phenylether) acrylate, (ethylene glycol phenylether) methacrylate, n-decyl acrylate, n-decyl methacrylate, iso-decyl acrylate, iso-decyl methacrylate, 10-undecenyl acrylate, 10-undecenyl methacrylate, tert-butylcyclohexyl acrylate, tert-butylcyclohexyl methacrylate, n-dodecyl acrylate, n-dodecyl methacrylate, n-octadecyl acrylate, n-octadecyl methacrylate, 2-phenoxyethyl acrylate, 2-phenoxyethyl methacrylate, 2-(2-methoxyethoxy)ethyl) acrylate, 2-(2-methoxyethoxy)ethyl) methacrylate, tetrahydrofurfuryl acrylate, tetrahydrofurfuryl methacrylate, (2-tetrahydropyranyl) acrylate, (2-tetrahydropyranyl) methacrylate, n-tridecyl acrylate, n-tridecyl methacrylate, behenyl acrylate, behenyl methacrylate or mixtures thereof.

The following are non-limiting examples of carboxyalkyl acrylate monomers suitable for use in forming the disclosed terpolymers: 2-carboxyethyl acrylate, 2-carboxyethyl methacrylate, 3-carboxypropyl acrylate, 3-carboxypropyl methacrylate, 4-carboxybutyl acrylate, 4-carboxybutyl methacrylate, 5-carboxypentyl acrylate, 5-carboxypentyl methacrylate, 3-methyl-3-carboxypropyl acrylate, 3-methyl-3-carboxypropyl methacrylate, 2,2-dimethyl-2-carboxyethyl acrylate, 2,2-dimethyl-2-carboxyethyl methacrylate, 3,3-dimethyl-3-carboxypropyl acrylate, 3,3-dimethyl-3-carboxypropyl methacrylate, 4-methyl-4-carboxybutyl acrylate, 4-methyl-4-carboxybutyl methacrylate or mixtures thereof.

The following are non-limiting examples of alkoxyalkyl acrylate monomers suitable for use in forming the disclosed terpolymers methoxymethyl acrylate, methoxymethyl methacrylate, 2-methoxyethyl acrylate, 2-methoxyethyl methacrylate, 2-ethoxyethyl acrylate, 2-ethoxyethyl methacrylate, 3-methoxypropyl acrylate, 3-methoxypropyl methacrylate, 3-methoxybutyl acrylate, 3-methoxybutyl methacrylate, 4-methoxybutyl acrylate, 4-methoxybutyl methacrylate, 5-methoxypentyl acrylate, 5-methoxypentyl methacrylate, 4-methoxypentyl acrylate, 4-methoxypentyl methacrylate, 3-methoxypentyl acrylate, 3-methoxypentyl methacrylate, 4-ethoxybutyl acrylate, 4-ethoxybutyl methacrylate, or mixture thereof.

Table 1 shows the number average molecular weights (M̅ₙ), as well as the polydispersity indexes, of random terpolymers based on alkyl acrylate, carboxyalkyl acrylate, and alkoxyalkyl acrylate, corresponding to the BuCE-1 series (as determined by SEC), wherein R₁ is n-butyl, R₂ si 2-carboxyethyl, R₃ is 2-methoxyethyl, and each R₄, R₅ and R₆ is hydrogen.

TABLE 1

| | Weight | | | Polidispersity |
|---|---|---|---|---|
| | ratio | Synthesis | M̅ₙ̅ | index |
| Terpolymer | (wt %) | method | (g mol⁻¹) | (I) |
| BuCE-6131 | 60/10/30 | Semicontinuous | 23483.76 | 2.02 |
| BuCE-6221 | 60/20/20 | Semicontinuous | 22150.35 | 1.89 |
| BuCE-6311 | 60/30/10 | Semicontinuous | 15622.85 | 1.95 |
| BuCE-7121 | 70/10/20 | Semicontinuous | 14045.10 | 1.79 |
| BuCE-7211 | 70/20/10 | Semicontinuous | 17859.45 | 2.03 |
| BuCE-8111 | 80/10/10 | Semicontinuous | 19839.36 | 1.62 |
| BuCE-9551 | 90/5/5 | Semicontinuous | 25601.47 | 1.55 |

Table 2 shows the number average molecular masses (MA) and polydispersity indexes of the random terpolymers based on alkyl acrylate, carboxyalkyl acrylate, and alkoxyalkyl acrylate, corresponding to the BuCE-2 series wherein R₁ is n-butyl, R₂ is 2-carboxyethyl, R₃ is 2-methoxyethyl, and each R₄, R₅ and R₆ is hydrogen.

TABLE 2

| | Weight | | | Polidispersity |
|---|---|---|---|---|
| | ratio | Synthesis | M̅ₙ̅ | index |
| Terpolymer | (wt %) | method | (g mol⁻¹) | (I) |
| BuCE-6132 | 60/10/30 | Semicontinuous | 19237.55 | 1.69 |
| BuCE-6222 | 60/20/20 | Semicontinuous | 17598.46 | 1.72 |
| BuCE-6312 | 60/30/10 | Semicontinuous | 12369.36 | 1.65 |
| BuCE-7122 | 70/10/20 | Semicontinuous | 12036.42 | 1.89 |
| BuCE-7212 | 70/20/10 | Semicontinuous | 16058.23 | 1.62 |
| BuCE-8112 | 80/10/10 | Semicontinuous | 17236.58 | 1.78 |
| BuCE-9552 | 90/5/5 | Semicontinuous | 19563.12 | 1.53 |

### Terpolymer Characterization

In order to describe in detail, the random acrylic terpolymers object of the present disclosure, the following demonstrative examples are shown, which should not be considered as limiting. The demonstrative terpolymers were characterized by means of the instrumental techniques listed below:
1. Nuclear magnetic resonance (NMR) to record the ¹H and ¹³C spectra, employing a Bruker® Bruker model AVANCE NEO, at frequencies of 600 MHz and 150 MHz; respectively. Deuterated chloroform (CDCl₃) was employed as solvent, while tetramethylsilane (TMS) was used as reference.
2. Fourier transform infrared spectroscopy (FTIR), specifically a Thermo Nicolet® AVATAR 330 model Fourier transform infrared spectrometer was employed to record the spectra. It was employed the film technique and the OMNIC 7.0® version software was used for the processing of data.
3. Size exclusion chromatography (SEC), employing an Agilent 1100 model size exclusion chromatograph, with a PLgel column, using tetrahydrofuran (THF) as eluent. This technique was employed to obtain the molecular mass distribution of terpolymers, as well as their polydispersity indexes (I).

### BuCE-1 and BuCE-2 Series

The primary characteristics of the BuCE-1 and BuCE-2 series of the disclosed terpolymers based on alkyl acrylate, carboxyalkyl acrylate, and alkoxyalkyl acrylate applied as dehydrating agents for crude oils with gravities between about 10 and about 40° API are described below.

I.R. n cm⁻¹: 3443.94, 2962.35, 2921.07, 2872.51, 1729.65, 1550.77, 1254.53, 1164.69, 1027.09.

NMR ¹H, d ppm: 4.39, 4.20, 4.04, 3.65, 3.58, 3.36, 2.68, 2.29, 1.91, 1.61, 1.60, 1.40, 1.38, 1.36, 1.33, 1.25, 0.96, 0.94, 0.91.

NMR ¹³C, d ppm: 174.64, 64.47, 63.33, 58.79, 41.42, 36.44, 35.36, 34.15, 31.94, 30.84, 29.65, 29.38, 22.72, 19.12, 14.17, 13.77.

### Assessment of the Disclosed Terpolymers

Once the dry terpolymers were obtained, solutions of each were prepared. Taking into account that the concentration of the terpolymer in solution can be set upon an interval from about 3 to about 50 wt %, small volumes of the solutions were utilized in order to eliminate the influence of the solvent on the dehydrating efficiency.

The efficiency of each of the novel terpolymeric demulsifying agents was compared with that of a known commercial formulation labeled as FD-01, which is comprised of different triblock PEO-PPO-PEO polyethers of different monomeric composition.

Table 3 displays the characteristics of the prior art polyethers that comprise the aforesaid formulation. Unlike the commercial formulation, the random acrylic terpolymers of the present disclosure display all three functions of a demulsifying agent, i.e., as a breaker of the asphaltenic barrier that surrounds the droplets, coalescer of the dispersed water droplets, and aqueous phase clarifier, in a single molecule; in contrast with the polyethers that normally must be applied as mixtures of at least three triblock bipolymers, thus that, each one performs a specific function, either as breaker, coalescer or clarifier. The foregoing implies a great advantage for the random acrylic terpolymers described in the present disclosure, since their cost is much lower than that of a blend of polyethers.

Likewise, the efficiency of the novel dehydrating terpolymers was compared with f a compound that has been considered as the universal demulsifier: F-46 product, which is an oxyalkylated ethylene aryl sulfonate-formaldehyde resin, which also contains alcohols, such as isopropanol and methanol, and some alkali metal halides, such as sodium chloride or potassium chloride. Its use as demulsifying agent has been reported previously (see e.g., Canadian patent no. 2818334).

Table 3 lists characteristics of the polyethers that comprise the FD-01 commercial formulation, including their respective number average molecular masses and PPO/PEO composition in wt/wt %.

TABLE 3
FD-01 formulation

| | M̅ₙ̅ | PPO/PEO composition |
|---|---|---|
| Designation | (g mol⁻¹) | (wt/wt %) |
| TP 89 | 7750 | 90/10 |
| TP 03 | 5330 | 70/30 |
| TP 14 | 3050 | 60/40 |
| TP 71 | 1400 | 90/10 |

### Assessment of Terpolymers

In order to assess the dehydrating efficiencies of the random terpolymers of the present disclosure is the following procedures were used. Taking into account the necessary amount of oblong bottles provided with caps, labeled by the number of compounds to evaluate, plus one more that corresponds to the crude oil without demulsifier agent (labeled as blank), an aliquot of the respective solution of random terpolymer based on alkyl acrylate, carboxyalkyl acrylate, and alkoxyalkyl acrylate or, in the corresponding case, the FD-01 commercial formulation or the F-46 universal demulsifier were added to the corresponding bottle. Afterwards, crude oil was poured into the bottle to complete 100 mL of total volume, and the first reading (corresponding to time zero) was taken for all the bottles. Subsequently, the bottles were placed in a thermal controlled bath at an established temperature (as example, 80° C.). The separated volume of water from the emulsion was measured each 5 min during the first hour; subsequently, each hour, during the remaining time of the assessment. It is important to mention that each assessment lasts 5 hours and that, the random acrylic terpolymers, as well as the FD-01 commercial formulation and the F-46 universal demulsifier, were evaluated at concentrations ranging from about 5 to about 3000 ppm.

Table 4 displays the characterization of the employed crude oils on the assessment of the random terpolymers based on alkyl acrylate, carboxyalkyl acrylate, and alkoxyalkyl acrylate object of the present disclosure.

TABLE 4
Physicochemical characterization and SARA analysis of the crude oils.

| Property | AC1 | AC2 | AC3 |
|---|---|---|---|
| API gravity (°) | 21.0 | 15.6 | 36.3 |
| Salt content | 19.0 | >430.0 | 38.2 |
| (lb mbb⁻¹) | | (>151.0) | |
| Paraffins content (wt %) | 51.4 | 1.4 | 9.0 |
| Runoff temperature (° C.) | −24.0 | −3.0 | <−45.0 |
| Water content by | 50.2 | 7.0 | 50.1 |
| distillation (vol %) | | | |
| Water and sediments | 50.3 | 7.5 | 50.4 |
| (vol %) | | | |
| Kinematic viscosity (mm² | 275.2 | 4277.0 | 4.0 |
| s⁻¹) @ 25° C. | | | |
| Number average | 367.0 | 786.2 | 256.2 |
| molecular mass by | | | |
| cryoscopy (g mol⁻¹) | | | |
| API gravity (°) | 933.1 | 1562.9 | 523.1 |

SARA analysis

| | | | |
|---|---|---|---|
| Saturates (wt %) | 28.4 | 32.1 | 23.6 |
| Aromatics (wt %) | 32.5 | 26.5 | 45.2 |
| Resins (wt %) | 29.5 | 21.8 | 19.9 |
| Asphaltenes (wt %) | 9.6 | 19.6 | 11.3 |

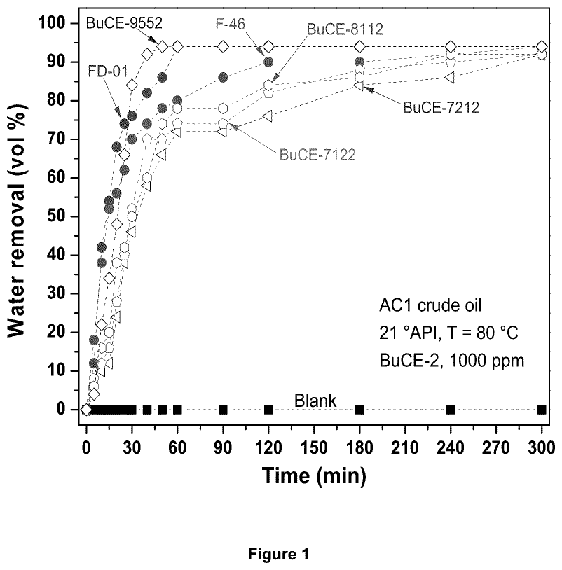

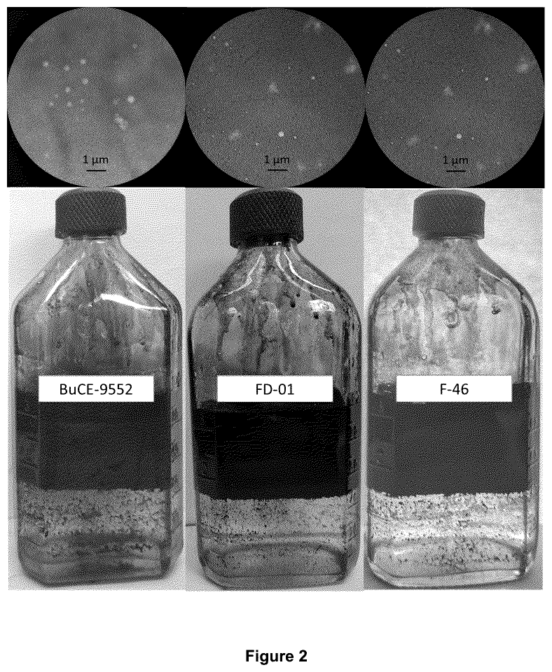

The data are illustrated in FIGS. 1, 3, 6, 8, and 10 which show the results of the assessment of the BuCE-1 and BuCE-2 terpolymers, as well as the FD-01 commercial formulation and the F-46 universal demulsifier, in the AC1, AC2, and AC3 crude oils reported in the Table 4 at different dosages. FIGS. 2, 4, 5, 7, 9, 11, and 12 display the clarifying capacities of the best terpolymers in each assessment, as well as the commercial products, and their respective micrographs of the organic phase.

As it relates to the BuCE-2 series, FIG. 1 displays the performance of the terpolymers of the BuCE-2 series at a concentration of 1000 ppm, being the BuCE-9552 the best terpolymer of the series, which removed 94 vol % of the emulsified water at 50 min after the assessment. Despite that both FD-01 and F-46 withdrew the same amount of emulsified water that the foregoing terpolymer, the coalescence rate of the BuCE-9552 terpolymer is similar to that of the FD-01 commercial formulation and remarkably superior to that exhibited by the F-46 demulsifier.

The BuCE-8112, BuCE-7121, and BuCE-7211 terpolymers removed 2 vol % less than the previously described products 92 vol %, at 240, 300, and 300 min, respectively. Their coalescence rates displayed a similar behavior during the assessment, as well as, slightly lower than both commercial products. Finally, the rest of terpolymers from the BuCE-2 series exhibited a dehydrating efficiency lower than 90 vol %.

As it relates to the clarifying capabilities of the BuCE-9552 terpolymer, the FD-01 and F-46 products, FIG. 2 shows that the abovementioned products displayed similar capacities, moreover, that the generated interfaces by the addition of any of the foregoing are homogeneous. In the same way, in their respective micrographs, it can be observed the presence of some dispersed water droplets, whose average size does not exceed 0.5 μm.

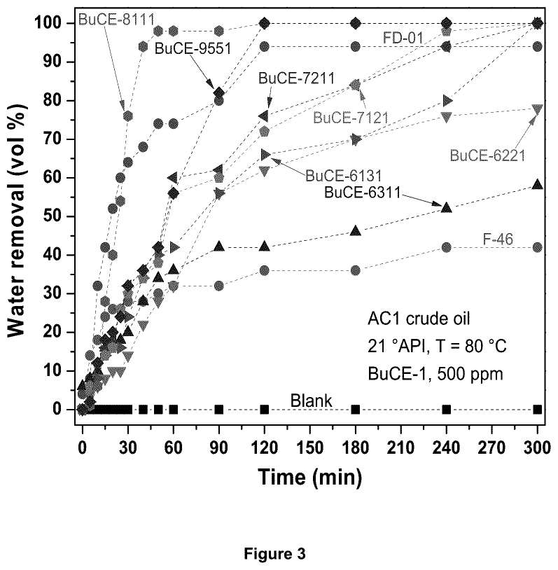

FIG. 3 exhibits that, when the assessment was carried out in the AC1 crude oil at 500 ppm, the FD-01 commercial formulation removed 94 vol % after 120 min of evaluation; nonetheless, regarding the BuCE-1 series, the BuCE-6131, BuCE-7211, BuCE-7121, BuCE-8111, and BuCE-9551 managed to withdraw all the emulsified water, surpassing both the commercial formulation and the universal demulsifier. About the above terpolymers, the BuCE-8111 terpolymer exhibited the highest coalescence rate from the series, overcoming the commercial formulation after 30 min and reaching its maximum dehydrating efficiency at 120 min; meanwhile, the BuCE-9551 terpolymer exceeded the coalescence rate displayed by the commercial formulation at 90 min, and reached its maximum removal efficiency at the end of the test, with similar coalescence rates observed up to 60 min. After this time, the BuCE-7121 and BuCE-7211 exhibited higher coalescence rates than the BuCE-6131 terpolymer.

As it relates to the BuCE-6221 and BuCE-6311 terpolymers, these removed 78 and 58 vol % of emulsified water, respectively. Both displayed the lowest coalescence rate of the series, reaching their maximum values at the end of the assessment; however, these overcame the coalescence rate exhibited by the F-46 universal demulsifier, which scarcely removed 42 vol % at 240 min. In general, the BuCE-1 series' efficiency slightly surpassed the efficiencies displayed by the BuCE-2 series.

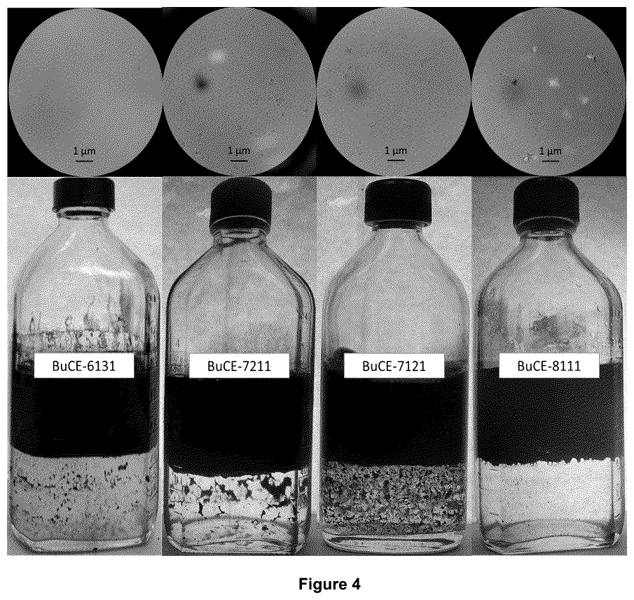

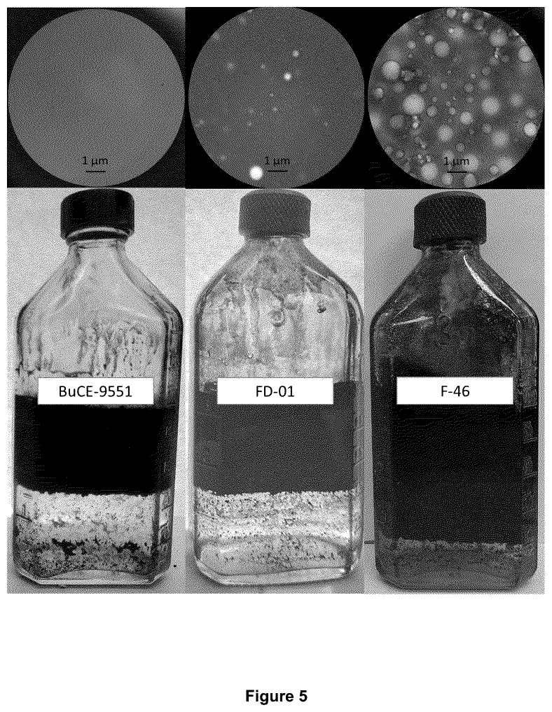

FIGS. 4 and 5 display that the clarifying capacity of the BuCE-7211, BuCE-7121, BuCE-8111 and BuCE-9551 terpolymers, which is similar to that exhibited by the FD-01 and F-46 products. Likewise, it can be appreciated that the generated interfaces after the treatment with the previous terpolymers, as well as with the BuCE-6131 terpolymer and both commercial products, are homogeneous. Similarly, the micrographs of the crude oil treated with all the foregoing terpolymers show the absence of dispersed water droplets, confirming the total removal of the emulsified water. On the other hand, regarding the micrograph of the crude oil dosed with the FD-01 commercial formulation, it can be observed some dispersed water droplets, whose diameter is in the range of less than 0.1 μm up to 0.7 μm, while the micrograph of the crude oil treated with the F-46 demulsifier displays a greater amount of dispersed water droplets with a greater size than those observed in the crude oil treated with the commercial formulation. In fact, the diameter of the water droplets is within the interval between 0.1 and 1.1 μm.

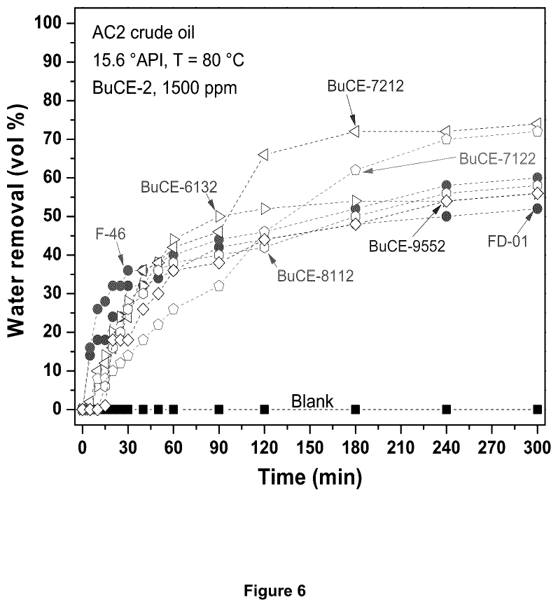

The results of the assessment of the BuCE-2 series and the commercial products in the AC2 crude oil—lower API gravity with respect to the AC1 crude oil, 15.6° API—at 1500 ppm are displayed in FIG. 6. Concerning the FD-01 and F-46 commercial products, their maximum removal efficiencies at the end of the assessment were 52 and 60 vol %, respectively. On the other side, the BuCE-7212 and BuCE-7122 terpolymers overcame the dehydrating efficiencies of both commercial demulsifiers, withdrawing 74 and 72 vol %, respectively at the end of the assessment, whereas the BuCE-7212 terpolymer exhibited a higher coalescence rate throughout the entire evaluation. On its behalf, the BuCE-8112 terpolymer removed 58 vol % at the end of the assessment, while the BuCE-6132 and BuCE-9552 terpolymers removed 2 vol % less than the previous terpolymer. It is worth mentioning that despite that both terpolymers exhibited similar dehydrating efficiencies, the coalescence rate of the BuCE-6132 terpolymer was superior to that of the BuCE-9552 terpolymer throughout the test. Finally, the BuCE-6222 and BuCE-6312 terpolymers were the only ones that displayed the lowest water removal efficiency of the series, withdrawing less than 50 vol % (48 and 38 vol %) after 240 and 300 min; respectively.

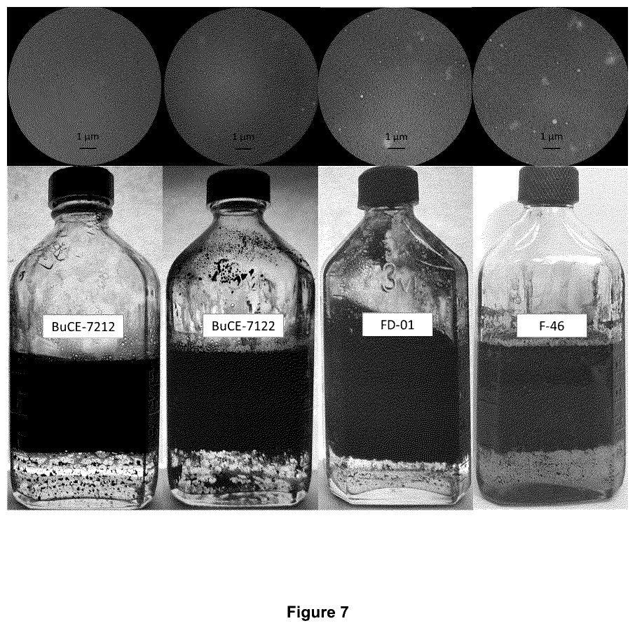

FIG. 7 shows that the clarifying capability of the FD-01 commercial formulation is comparable with that displayed by the BuCE-7212 and BuCE-7122 terpolymers. Moreover, the clarifying capacity of the F-46 universal demulsifier is significantly lower than that exhibited by the previous products. Regarding the generated interfaces, it can be appreciated that all are slightly heterogeneous, except for that of the BuCE-7212 terpolymer, which displays an interface slightly more homogeneous. Regarding the micrographs, it can be noted that the average droplet size does not exceed 0.1 μm; in the specific case of the micrograph of the crude oil treated with the FD-01 commercial formulation, where it can be observed some water droplets of 0.1 μm, similar to that shown in the micrograph of crude oil treated with the F-46 universal demulsifier. However, it is important to point out that, with respect to the micrographs of the crude oil treated with both terpolymers, the amount of dispersed water droplets is significantly lower than those treated with both commercial products.

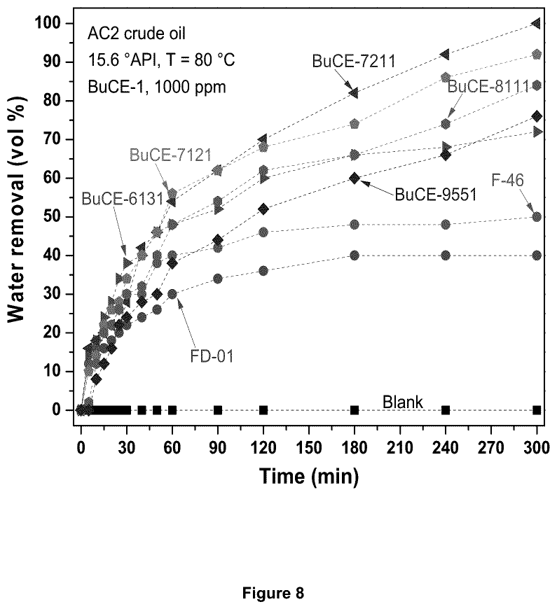

The assessments for the BuCE-1 series in the AC2 crude oil are reported in the FIG. 8, where it can be observed that the efficiency of FD-01 and F-46 products was lower than 60 vol %, exactly 40 and 50 vol % at 180 and 300 min, respectively. Concerning the acrylic polymers, the BuCE-7211 terpolymer was the only one capable of removing all the emulsified water at the end of the assessment. The BuCE-7121 terpolymer was the second-best dehydrating agent of the assessment, removing 92 vol % of the emulsified water at 300 min; while the BuCE-8111 terpolymer removed 8 vol % less than the BuCE-7121. The BuCE-9551 and BuCE-6131 terpolymers withdrew 76 and 72 vol % of the emulsified water, respectively; nonetheless, the BuCE-6131 terpolymer exhibited a higher coalescence rate during 240 min of the assessment. Finally, the terpolymers that exhibited the lowest demulsifying efficiency in the evaluation were BuCE-6221 and BuCE-6311, which removed 44 (300 min) and 30% v (240 min), respectively.

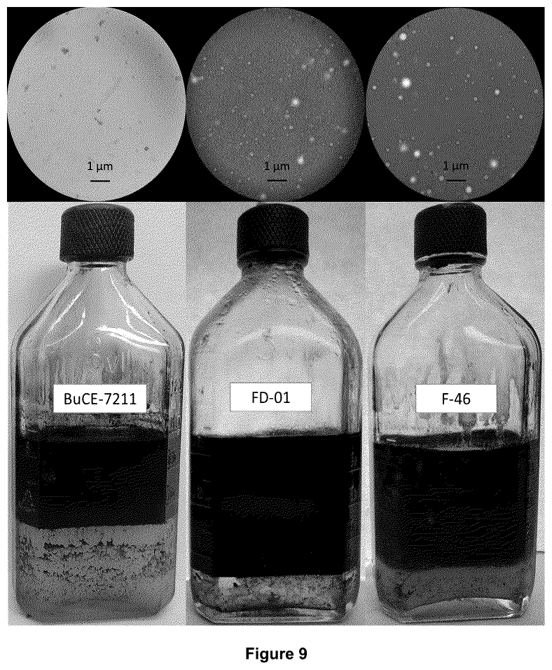

FIG. 9 shows that the interfaces generated by the FD-01 commercial formulation and the BuCE-7211 terpolymer are homogeneous, in contrast with that observed with the F-46 universal demulsifier. In the same way, it can be observed that the clarifying capacity of the F-46 universal demulsifier is similar to the obtained with the BuCE-7211 terpolymer. The clarifying capability exhibited by the FD-01 commercial formulation is slightly superior to that of the terpolymer and the universal demulsifier; nevertheless, it is important to highlight the notable difference in the water removal volume for the random acrylic terpolymer compared with both commercial products.

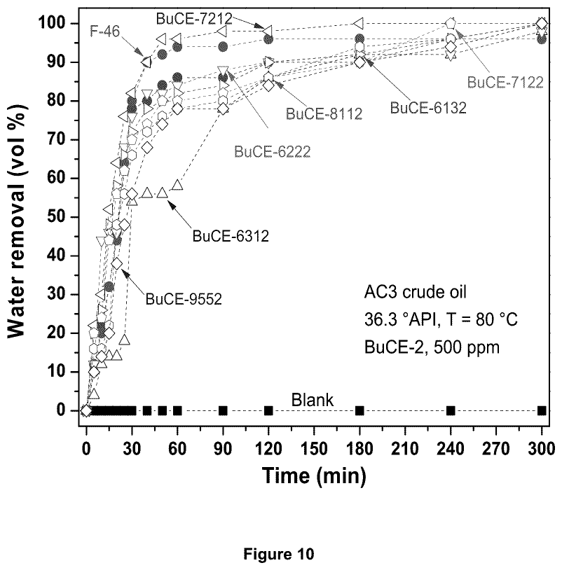

The assessment of the BuCE-1 and BuCE-2 series in the AC3 light crude oil of 36.3° API, only the BuCE-2 series displayed significant dehydrating activity. FIG. 10 exhibits the dehydrating efficiency of the BuCE-2 series and both commercial products at a concentration of 500 ppm in the aforesaid crude oil. Regarding the FD-01 commercial formulation, this withdrew all the emulsified water at the end of the assessment, matching the efficiency of the BuCE-6132, BuCE-7212, BuCE-7122, BuCE-8112, and BuCE-9552 terpolymers. However, it should be mentioned that the coalescence rates of the BuCE-7212 and BuCE-7122 were slightly superior to those exhibited by the FD-01 commercial formulation, because both terpolymers reached their maximum demulsifying efficiency at 180 and 240 min, respectively. Regarding the BuCE-6132 terpolymer, its coalescence rate was greater than that of the commercial formulation during the first 20 min of the assessment; subsequently, both products, the commercial formulation and the terpolymer, displayed similar coalescence rates. Concerning the BuCE-8112 terpolymer, it exhibited a resembling coalescence rate to that of the FD-01 commercial formulation, while the BuCE-9552 terpolymer displayed a slightly lower coalescence capability than that of the FD-01.

On the other hand, the BuCE-6222 and BuCE-6312 were capable of withdrawing 98 vol % of the emulsified water at the end of the assessment, overcoming the maximum dehydration efficiency displayed by the F-46 universal demulsifier, which removed 96 vol % from 120 min of the assessment.

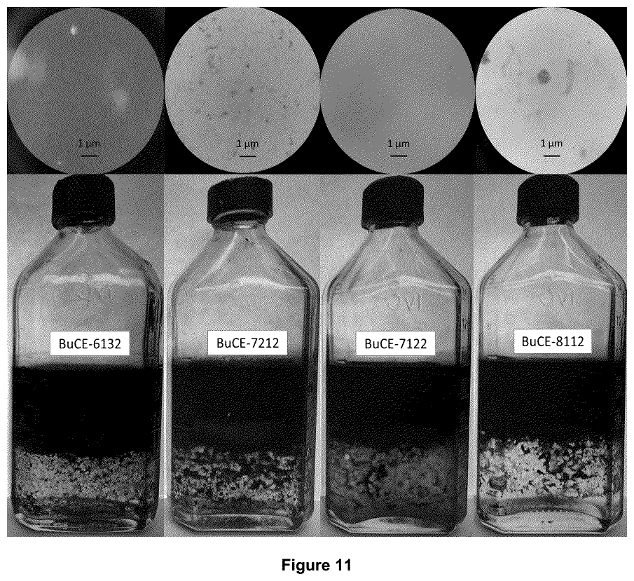

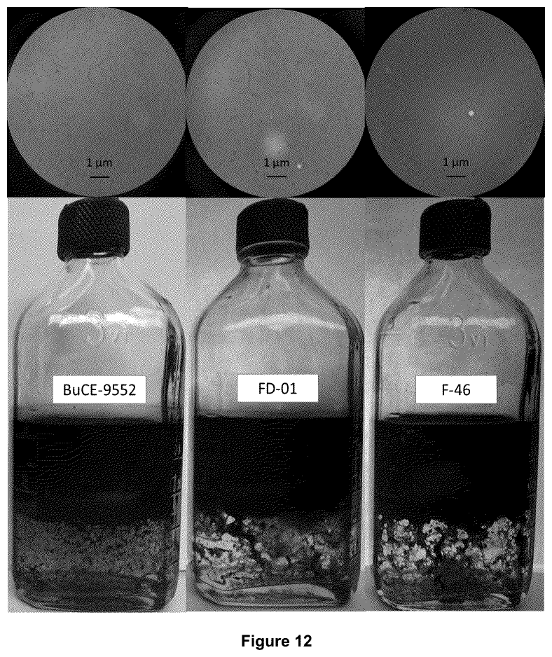

In relation to the clarifying capacities of the best products, FIGS. 11 and 12 show that both commercial products display a similar performance to that of the BuCE-6132, BuCE-7212, BuCE-8112, and BuCE-9552 terpolymers. The only terpolymer that displays a slightly lower clarifying capacity is the BuCE-7122; however, the interface generated by this product is similar to the rest of the terpolymers, in contrast with the slightly heterogeneous interfaces obtained with the commercial products.

Concerning the micrographs, it is evident the absence of dispersed water droplets in the organic phase in all the images corresponding to the acrylic terpolymers. With respect to the micrographs corresponding to the crude oil treated with the F-46 universal demulsifier, it can be appreciated some dispersed water droplets with a diameter less than 0.1 μm; meanwhile, the micrograph of the crude oil dosed with FD-01 unveils some dispersed water droplets, whose average diameter does not exceed 0.1 μm.

All the demonstrative examples previously described show the dehydrating capacity of the random terpolymers based on alkyl acrylate, carboxyalkyl acrylate, and alkoxyalkyl acrylate of different molecular mass when are dosed in crude oils of different API gravities, particularly whose gravities are in the range from about 10 to about 40° API.

### REFERENCES

[1] Umar, A. A; Said, I. B. M; Sulaimon, A. A; Pilus, R. B. M. A review of petroleum emulsions and recent progress on water-in-crude oil emulsions stabilized by natural surfactants and solids. J. Pet. Sci. Eng. 2018, 165, 673-690.
[2] Schorling, P. C; Kessel, D. G; Rahimian, I. Influence of the crude oil resin/asphaltene ratio on the stability of oil/water emulsions. Colloids Surf., A. 1999, 152(1-2), 95-102.
[3] Aman, Z. M; Haber, A; Ling, N. N. A; Thornton, A; Johns, M. L; May, E. F. Effect of brine salinity on the stability of hydrate-in-oil dispersions and water-in-oil emulsions. Energy Fuels. 2015, 29(12), 7948-7955.
[4] Kokal, S. L. Crude oil emulsions: A state-of-the-art review. SPE Prod. Facil. 2005, 20(1), 5-13.
[5] Fortuny, M; Oliveira, C. B. Z; Melo, R. L. F. V; Nele, M; Coutinho, R. C. C; Santos, A. F. Effect of salinity, temperature, water content, and pH on the microwave demulsification of crude oil emulsions. Energy Fuels. 2007, 21(3), 1358-1364.
[6] Sullivan, A. P; Zaki, N. N; Sjöblom, J; Kilpatrick, P. K. The stability of water-in-crude and model oil emulsions. Can. J. Chem. Eng. 2008, 85(6), 793-807.
[7] Da Silva, M; Sad, C. M. S; Pereira, L. B; Corona, R. R. B; Bassane, J. F. P; Dos Santos, F. D; Neto, D. M. C; Silva, S. R. C; Castro, E. V. R; Filgueiras, P. R. Study of the stability and homogeneity of water in oil emulsions of heavy oil. Fuel 2018, 226, 278-285.
[8] Subramanian, D; May, N; Firoozabadi, A. Functional molecules and the stability of water-in-crude oil emulsions. Energy Fuels 2017, 31(9), 8967-8977.
[9] Zhang, Z; Xu, G. Y; Wang, F; Dong, S. L; Li, Y. M. Characterization and demulsification of poly(ethylene oxide)-block-poly(propylene oxide)-block-poly(ethylene oxide) copolymers. J.

Colloid Interface Sci. 2004, 277(2), 464-470.
[10] Al-Sabagh, A. M; Kandile, N. G; El-Din, M. R. N. Functions of demulsifiers in the petroleum industry. Sep. Sci. Technol. 2011, 46(7), 1144-1163.
[11] Cendejas, G; Arreguin, F; Castro, L. V; Flores, E. A; Vazquez, F. Demulsifying super-heavy crude oil with bifunctionalized block copolymers. Fuel 2013, 103, 356-363.
[12] Álvarez, F; Flores, E. A; Castro, L. V; Hernández, J. G; López, A; Vázquez, F. Dissipative Particle Dynamics (DPD) study of crude oil-water emulsions in the presence of a functionalized co-polymer. Energy Fuels 2011, 25(2), 562-567.
[13] Dragoi, B; Laurent, G; Casale, S; Benamor, T; Lebeau, B; Boissiére, C; Ribot, F; Selmane, M; Schmidt, P; Kreher, D; Davidson, A. Stability and degradation of PEO20PPO70PEO20 triblock copolymers in mesostructured silica. J. Sol-Gel Sci. Technol. 2019, 91, 552-566.
[14] Biniaz, P; Farsi, M; Rahimpour, M. R. Demulsification of water in oil emulsion using ionic liquids: Statistical modeling and optimization. Fuel 2016, 184, 325-333.
[15] Adewunmi, A. A; Kamal, M. S. Demulsification of water-in-oil emulsions using ionic liquids: Effects of counterion and water type. J. Mol. Liq. 2019, 279, 411-419.
[16] Guzmán-Lucero, D; Flores, P; Rojo, T; Martinez-Palou, R. Ionic liquids as demulsifiers of water-in-crude oil emulsions: Study of the microwave effect. Energy Fuels 2010, 24(6), 3610-3615.
[17] George, A; Brandt, A; Tran, K; Zahari, S. M. S. N. S; Klein-Marcuschamer, D; Sun, N; Sathitsuksanoh, N; Shi, J; Stavila, V; Parthasarathi, R; Singh, S; Holmes, B. M; Welton, T; Simmons, B. A; Hallett, J. P. Design of low-cost ionic liquids for lignocellulosic biomass pretreatment. Green Chem. 2015, 17(3), 1728-1735.
[18] Stephenson, W. K. Alkoxylated vinyl polymer demulsifiers. U.S. Pat. No. 4,968,449. Nov. 6, 1990.
[19] Cevada, E; Palacios, N; Hernández, E; Castro, L; López, A; Flores, C; Álvarez, F; Vázquez, F. Novel petroleum demulsifiers based on acrylic random copolymers. J. Dispersion Sci. Technol. 2019, 40(4), 495-506.
[20] Fuentes, J. V; Zamora, E. B; Li, Z; Xu, Z; Chakraborty, A; Zavala, G; Vázquez, F; Flores, C. (2021). Alkylacrylic-carboxyalkylacrylic random bipolymers as demulsifiers for heavy crude oil. Sep. Purif. Technol. 256, 117850.
[21] Hernández Carbajal, E.1; López Ortega, A; Flores Sandoval, C. A; Álvarez Ramirez, F; Vázquez Moreno, F. S; Zavala Olivares, G; Clavel López, J. C; Garcia Jimenez, R. J. Desemulsionantes para aceites crudos con base en copolimeros aleatorios acrilico-aminoacrilico de masa molecular controlada. Mexican patent document No. 386485. Sep. 15, 2021.
[22] Hernández Carbajal, E.1; Flores Sandoval, C. A; Álvarez Ramirez, F; López Ortega, A; Garcia Jimenez, R. J; Zavala Olivares, G; Clavel López, J. C; Vázquez Moreno, F. S. Demulsifiers for crude oil based on acrylic-aminoacrylic random copolymers of controlled molecular mass. U.S. Pat. No. 10,975,185. Apr. 13, 2021.
[23] Flores Sandoval, C. A; Chávez Mora, M. A; Zamora Guerrero, E. B; López Ortega, A; Zavala Olivares, G.; Álvarez Ramirez, F.; Vázquez Moreno, F. S. Water/crude oil removers based on alkylacrylic-carboxyalkylacrylic random copolymers of controlled molecular mass. U.S. Pat. No. 10,793,783, Oct. 6, 2020.
[24] Flores Sandoval, C. A; Chávez Mora, M. A; Zamora Guerrero, E. B; Lopez Ortega, A; Zavala Olivares, G; Álvarez Ramirez, F; Vázquez Moreno, F. S. Water/crude oil removers based on alkylacrylic-carboxyalkylacrylic random copolymers of controlled molecular mass. Canadian patent No. 3,013,494. Dec. 8, 2020.
[25] Gómez, E; Fuentes, J. V; Zamora, E. B; Vargas, C. J; Cevada, E; Zavala, G; Álvarez, F; Flores, C; Vázquez, F. (2020). Bipolimeros de adición con alta aleatoriedad para desestabilización de emulsiones complejas en mezclas de aceites crudos. Mexican patent application No. MX/a/2020/011505. Oct. 29, 2020.
[26] Gómez, E; Fuentes, J. V; Zamora, E. B; Vargas, C. J; Cevada, E; Zavala, G; Álvarez, F; Flores, C; Vázquez, F. Highly random addition bipolymers for destabilization of complex emulsions in crude oil blends. United States patent application 20220135886. May 5, 2022.
[27] Ma, S; Xu, P; Cai, Z; Qin, H; Fu, X; Zhang, Z; Ye, Z; Xue, J. Development of a novel terpolymer as a green and efficient decalcifying agent for crude petroleum. ACS Omega. 2018, 3(10) 13170-13178.
[28] Feng, L; Zhang, Z; Wang, F; Wang, T; Yang, S. Synthesis and evaluation of alkyl acrylate-vinyl acetate-maleic anhydride terpolymers as cold flow improvers for diesel fuel.

Fuel Process. Technol. 2014, 118, 42-48.
[29] Vargas Martinez, C. J; Flores Sandoval, C. A; Zamora Guerrero, E. B; Álvarez Ramirez, F; Vázquez Moreno, F. S; Zavala Olivares, G; Fuentes Santiago, J. V. Desemulsionantes para aceite crudo con base en terpolímeros aleatorios alquilacrílico-aminoacrilico-carboxiacrilico de masa molecular controlada. Mexican patent application No. Mx/a/2020/002212. Sep. 20, 2021.
[30] Vargas Martinez, C. J; Zamora Guerrero, E. B; Flores Sandoval, C. A; Vázquez Moreno, F. S; Álvarez Ramirez, F; Zavala Olivares, G; Fuentes Santiago, J. V; Cevada Maya, E; Gómez Buendia, E. Nuevas macromoléculas alquiladas, aminadas y alcoxiladas con propiedades trifuncionales integradas para la remoción de emulsiones de petróleo. Mexican patent application No. Mx/a/2020/010501. Oct. 5, 2020.
[31] Benz, P. H; Ors, J. A. Polymers for intraocular lenses. U.S. Pat. No. 8,318,832. Nov. 17, 2012.
[32] Seymour, D. E; Da Costa, N. M. Polymers of alkoxy and hydroxy alkyl acrylates or methacrylates. U.S. Pat. No. 3,780,003. Dec. 18, 1973.

What is claimed is:

1. A random terpolymer having structural formula (1): 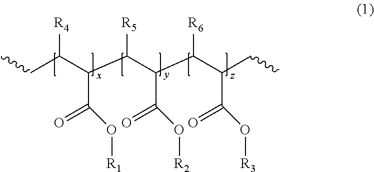
wherein:
each R₁ is independently selected from substituted or unsubstituted CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₆H₁₁ (di(ethylene glycol)ethylether), C₈H₁₇ (2-ethylhexyl), C₆H₁₉ (3,5,5-trimethylhexyl), C₈H₁₇ (n-octyl), C₈H₁₇ (iso-octyl), C₃H₉ (ethylene glycol phenylether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₃H₉O (2-phenoxyethyl), C₃H₇O (2-methoxyethyl), C₅H₁₁O₂ (2-(2-methoxyethoxy)ethyl), C₅H₉O (tetrahydrofurfuryl), C₅H₉O (2-tetrahydropyranyl), C₁₃H₂₇ (n-tridecyl) or C₂₂H₄₅ (behenyl), wherein the substitution can be one or more chain inserted heteroatoms, aryl or heteroaryl groups;
each R₂ is independently selected from C₃H₅O₂ (2-carboxyethyl), C₄H₇O₂ (3-carboxypropyl), C₅H₉O₂ (4-carboxybutyl), C₆H₁₁O₂ (5-carboxypentyl), C₅H₉O₂ (3-methyl-3-carboxypropyl), C₅H₉O₂ (2,2-dimethyl-2-carboxyethyl), C₆H₁₁O₂ (3,3-dimethyl-3-carboxypropyl), C₆H₁₁O₂ (4-methyl-4-carboxybutyl);
each R₃ is independently selected from C₂H₅O (methoxymethyl), C₃H₇O (2-methoxyethyl), C₄H₉O (2-ethoxyethyl), C₄H₉O (3-methoxypropyl), C₅H₁₁O (3-methoxybutyl), C₅H₁₁O (4-methoxybutyl), C₆H₁₃O (5-methoxypentyl), C₆H₁₃O (4-methoxypentyl), C₆H₁₃O (3-methoxypentyl), C₆H₁₃O (4-ethoxybutyl);
R₄, R₅ and R₆ are each independently selected from H (hydrogen), and CH₃ (methyl); and
x is an integer from about 1 to about 1220;
y is an integer from about 1 to about 500; and
z is an integer from about 1 to about 500;
and the polymeric subunits of x alkyl-acrylate monomers, y carboxyalkyl-acrylate monomers, and z alkoxyalkyl-acrylate monomers can be present in any order.

2. The random terpolymer according to claim 1, wherein the alkyl acrylate monomer used to prepare the terpolymer is selected from: methyl acrylate, methyl methacrylate, ethyl acrylate, ethyl methacrylate, n-butyl acrylate, n-butyl methacrylate, iso-butyl acrylate, iso-butyl methacrylate, tert-butyl acrylate, tert-butyl methacrylate, pentyl acrylate, pentyl methacrylate, hexyl acrylate, hexyl methacrylate, (di(ethylene glycol)ethyl ether acrylate), (di(ethylene glycol)ethylether) methacrylate, 2-ethylhexyl acrylate, 2-ethylhexyl methacrylate, (3,5,5-trimethylhexyl) acrylate, (3,5,5-trimethylhexyl) methacrylate, n-octyl acrylate, n-octyl methacrylate, iso-octyl acrylate, iso-octyl methacrylate, (ethylene glycol phenylether) acrylate, (ethylene glycol phenylether) methacrylate, n-decyl acrylate, n-decyl methacrylate, iso-decyl acrylate, iso-decyl methacrylate, 10-undecenyl acrylate, 10-undecenyl methacrylate, tert-butylcyclohexyl acrylate, tert-butylcyclohexyl methacrylate, n-dodecyl acrylate, n-dodecyl methacrylate, n-octadecyl acrylate, n-octadecyl methacrylate, 2-phenoxyethyl acrylate, 2-phenoxyethyl methacrylate, 2-(2-methoxyethoxy)ethyl) acrylate, 2-(2-methoxyethoxy)ethyl) methacrylate, tetrahydrofurfuryl acrylate, tetrahydrofurfuryl methacrylate, (2-tetrahydropyranyl) acrylate, (2-tetrahydropyranyl) methacrylate, n-tridecyl acrylate, n-tridecyl methacrylate, behenyl acrylate, behenyl methacrylate or mixtures thereof.

3. The random terpolymer according to claim 1, wherein the carboxyalkyl acrylate monomer used to prepare the terpolymer is selected from: 2-carboxyethyl acrylate, 2-carboxyethyl methacrylate, 3-carboxypropyl acrylate, 3-carboxypropyl methacrylate, 4-carboxybutyl acrylate, 4-carboxybutyl methacrylate, 5-carboxypentyl acrylate, 5-carboxypentyl methacrylate, 3-methyl-3-carboxypropyl acrylate, 3-methyl-3-carboxypropyl methacrylate, 2,2-dimethyl-2-carboxyethyl acrylate, 2,2-dimethyl-2-carboxyethyl methacrylate, 3,3-dimethyl-3-carboxypropyl acrylate, 3,3-dimethyl-3-carboxypropyl methacrylate, 4-methyl-4-carboxybutyl acrylate, 4-methyl-4-carboxybutyl methacrylate or mixtures thereof.

4. The random terpolymer according to claim 1, wherein the alkoxyalkyl acrylate monomer used to prepare the terpolymer is selected from: methoxymethyl acrylate, methoxymethyl methacrylate, 2-methoxyethyl acrylate, 2-methoxyethyl methacrylate, 2-ethoxyethyl acrylate, 2-ethoxyethyl methacrylate, 3-methoxypropyl acrylate, 3-methoxypropyl methacrylate, 3-methoxybutyl acrylate, 3-methoxybutyl methacrylate, 4-methoxybutyl acrylate, 4-methoxybutyl methacrylate, 5-methoxypentyl acrylate, 5-methoxypentyl methacrylate, 4-methoxypentyl acrylate, 4-methoxypentyl methacrylate, 3-methoxypentyl acrylate, 3-methoxypentyl methacrylate, 4-ethoxybutyl acrylate, 4-ethoxybutyl methacrylate, or mixture thereof.

5. The random terpolymer according to claim 1, comprising from about 55.0 to about 99.4 wt % of the alkyl acrylate monomer, from about 0.3 to about 44.7 wt % of the carboxyalkyl acrylate monomer and from about 0.3 to about 44.7 wt % of the alkoxyalkyl acrylate monomer.

6. The random terpolymer according to the claim 1, wherein the random terpolymer is formulated as dissolution comprising an organic solvent such as dichloromethane, methanol, ethanol, isopropanol, chloroform, benzene and derivatives, toluene, xylene, turbosine, and naphtha; to be employed as demulsifying agent.

7. The random terpolymer according to the claim 6, wherein the random terpolymer is formulated as a dissolution in an amount from about 3 to about 50 wt %, in order to be employed as demulsifying agent. The use of a random terpolymer according to claim 1 as a demulsifying agent for removing emulsified water in crude oils.

8. The use of a random terpolymer according to claim 1 as a demulsifying agent for removing emulsified water in crude oils.

9. The use of claim 8, wherein the API gravity of the crude oil is from about 10 to about 40° API,

10. A method for removing emulsified water in crude oils of API gravity from about 10 to about 40° API, the method comprising dosing a demulsifying agent dissolution in the crude oil mixture, wherein the demulsifying agent comprises a random terpolymer according to the claim 1.

11. The method of claim 10, wherein the demulsifying agent is dosed at concentrations ranging from about 5 to about 3000 ppm.
